(19) United States
(12) Patent Application Publication
(10) Pub. No.: US 2024/0244166 A1
(43) Pub. Date: Jul. 18, 2024

(54) PROJECTOR

(71) Applicant: SEIKO EPSON CORPORATION, Tokyo (JP)

(72) Inventor: Akihiro KASHIWAGI, AZUMINO-SHI (JP)

(21) Appl. No.: 18/414,776

(22) Filed: Jan. 17, 2024

(30) Foreign Application Priority Data
Jan. 17, 2023 (JP) 2023-004928

(51) Int. Cl. H04N 9/31

(52) U.S. Cl. CPC H04N 9/317

(57) ABSTRACT

A projector includes a light source, a light modulation device that includes a color filter and modulates light output from the light source to generate color image light, a first optical system that the light from the light source enters, a second optical system that outputs the light from the first optical system toward the light modulation device, and a projection optical apparatus that projects the color image light.

### PROJECTOR

The present application is based on, and claims priority from JP Application Serial Number 2023-004928, filed Jan. 17, 2023, the disclosure of which is hereby incorporated by reference herein in its entirety.

### BACKGROUND

### 1. Technical Field

The present disclosure relates to a projector.

### 2. Related Art

There has been a known projector using a single liquid crystal panel as an optical modulation device, what is called a single-panel projector. Chinese Utility Model Registration No. 212,515,320 discloses a projector including a light source, a tapered reflector, a collimator lens, a liquid crystal panel, a focusing lens, a mirror, and an imaging lens.

Chinese Utility Model Registration No. 212,515,320 is an example of the related art.

When a solid-state light source such as a light emitting diode (LED) is used in a projector, the light emitting surface of the LED is typically smaller than the size of the liquid crystal panel. It is therefore necessary to use an enlarging optical system that enlarges the luminous flux width when the light output from the light source enters the liquid crystal panel. The projector disclosed in Chinese Utility Model Registration No. 212,515,320 uses the tapered reflector as the enlarging optical system. That is, the light output from the light source is reflected off the inner surface of the reflector and then incident on the liquid crystal panel with the luminous flux width enlarged.

In a projector including a single light modulation device, too large a dimension of the reflector in the optical axis direction may greatly increase the size of the projector. Therefore, part of the light emitted from the LED is reflected off the inner surface of the reflector and then output from the reflector, but the other part of the light emitted from the LED is output from the reflector without being reflected off the inner surface of the reflector. The light that is a mixture of the light reflected off the reflector and the light not reflected off the reflector enters a downstream optical system such as a collimator lens. In this case, in particular, there is a problem of an increase in variation of the angle of incidence of the light at an outer circumferential portion of the effective display region of the light modulation device, which tends to reduce the image brightness and contrast.

### SUMMARY

To solve the problem described above, a projector according to an aspect of the present disclosure includes a light source that outputs light, a light modulation device that includes a color filter and modulates the light output from the light source based on image information to generate color image light, a first optical system which is provided on an optical path of the light between the light source and the light modulation device and which the light output from the light source enters, a second optical system which is provided on the optical path of the light between the first optical system and the light modulation device and which outputs the light output from the first optical system toward the light modulation device, and a projection optical apparatus that projects the color image light output from the light modulation device. The first optical system includes a reflection element that includes a light incident section, a light exiting section having an area greater than an area of the light incident section, and a reflection surface, and reflects the light incident via the light incident section off the reflection surface to output the reflected light via the light exiting section. The second optical system includes a first lens which has positive power, which part of the light output from the first optical system enters, and which has a first principal point, and a second lens which has positive power, which part of the light output from the first optical system enters, and which has a second principal point at a position where the second principal point does not coincide with the first principal point when viewed in a direction along an optical axis of the light modulation device.

### BRIEF DESCRIPTION OF THE DRAWINGS

FIG. 1 is a schematic configuration diagram of a projector according to a first embodiment.

FIG. 2 is a front view of a reflection element viewed in the direction along a first optical axis.

FIG. 3 is a front view of a multi-lens viewed in the direction along the first optical axis.

FIG. 4 is a diagrammatic view showing how light output is reflected off a reflection element.

FIG. 5 shows a distribution of the angle of incidence of the light incident on a central portion of a liquid crystal panel in a projector of related art.

FIG. 6 shows another distribution of the angle of incidence of the light reflected off the reflection element on the central portion of the liquid crystal panel in the projector of related art.

FIG. 7 shows a distribution of the angle of incidence of the light incident on an outer circumferential portion of the liquid crystal panel in the projector of related art.

FIG. 8 shows another distribution of the angle of incidence of the light reflected off the reflection element on the outer circumferential portion of the liquid crystal panel in the projector of related art.

FIG. 9 shows a distribution of the angle of incidence of the light incident on the outer circumferential portion of the liquid crystal panel in the projector according to the first embodiment.

FIG. 10 is a schematic configuration diagram of the projector according to a second embodiment.

FIG. 11 is a diagrammatic view showing how the light passes through the multi-lens in a second optical system in the second embodiment.

FIG. 12 is a diagrammatic view showing how the light passes through a Fresnel lens in a projector according to Comparative Example.

FIG. 13 shows an example of another configuration of the multi-lens.

### DESCRIPTION OF EMBODIMENTS

### First Embodiment

A first embodiment of the present disclosure will be described below in detail with reference to the drawings.

In the drawings used in the description below, a characteristic portion is enlarged in some cases for clarity of the characteristic thereof, and the dimension ratio and other factors of each component are therefore not always equal to actual values.

An example of a projector according to the present embodiment will be described.

A projector 10 according to the present embodiment is a projection-type image display apparatus that displays a color image on a projection receiving surface such as a screen.

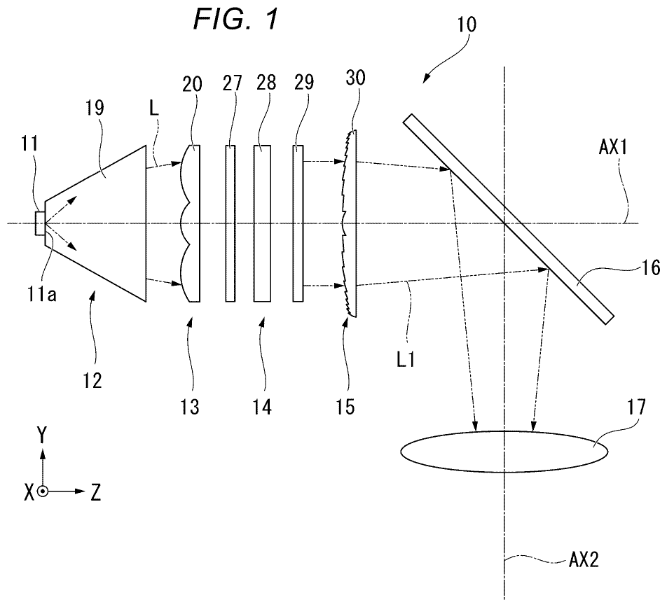

FIG. 1 is a schematic configuration diagram of the projector 10 according to the present embodiment.

The projector 10 according to the present embodiment includes a light source 11, a first optical system 12, a second optical system 13, a light modulator 14, a condenser system 15, a mirror 16, and a projection optical apparatus 17, as shown in FIG. 1.

An XYZ orthogonal coordinate system is used as required in the following description. The X-axis is an axis along an upward-downward direction of the projector 10. The Y-axis is an axis along the image projection direction of the projector 10, that is, along a frontward-rearward direction of the projector 10. The Z-axis is an axis along a rightward-leftward direction of the projector 10 and perpendicular to the X-axis and the Y-axis. In the description of the arrangement and shapes of the members of the projector 10, the three directions described above are defined in some cases as follows: the upward-downward direction is the direction parallel to the X-axis direction, which corresponds to the height in the front view of the projector 10 viewed from the side facing a projected image; the rightward-leftward direction is the direction parallel to the Z-axis direction, which corresponds to the lateral direction in the front view of the projector 10 viewed from the side facing the projected image; and the frontward-rearward direction is the direction parallel to the Y-axis direction, which corresponds to the depth in the front view of the projector 10 viewed from the side facing the projected image. These notations are definitions for describing the arrangement of the constituent members of the projector 10, and do not limit the installation posture or direction of the projector 10.

In the projector 10 according to the present embodiment, the axis along the principal beam of light L output from the light source 11, passing through the center of the light modulator 14, and parallel to the Z-axis is defined as a first optical axis AX1. The first optical axis AX1 is the optical axis of the light modulator 14, and corresponds to the optical axis in the claims. An axis along the optical axis of the projection optical apparatus 17 and parallel to the Y-axis is defined as a second optical axis AX2.

The light source 11 is provided on the first optical axis AX1. The light source 11 is formed, for example, of a light emitting diode (LED). The light source 11 outputs the light L, which is unpolarized light and has a predetermined angle of divergence. In the present specification, the unpolarized light L is defined as light that does not have a specific polarization state, such as linearly polarized light or circularly polarized light. The unpolarized light L is, for example, randomly polarized light. Since the light source 11 is formed of an LED, the projector 10 can be a small, light apparatus. The light L is emitted isotropically from a light emitting surface 11a, so that the light L output from the light source 11 has a circular cross-sectional shape perpendicular to the first optical axis AX1. The light source 11 is fixed to a light incident surface 19a of a reflection element 19, which will be described later.

The first optical system 12 is provided on the optical path of the light L between the light source 11 and a light modulation device 28, and the light L output from the light source 11 enters the first optical system 12. The first optical system 12 is formed of the reflection element 19 made of a light transmissive material, such as glass, and having a truncated quadrangular pyramidal shape. That is, when viewed from the direction along the first optical axis AX1, the reflection element 19 has a trapezoid shape having a width that increases in the direction from the light source 11 toward the light modulation device 28. The first optical system 12 makes the angle of divergence of the light L output from the first optical system 12 smaller than the angle of divergence of the light L before entering the first optical system 12 and outputs the resultant light L toward the second optical system 13.

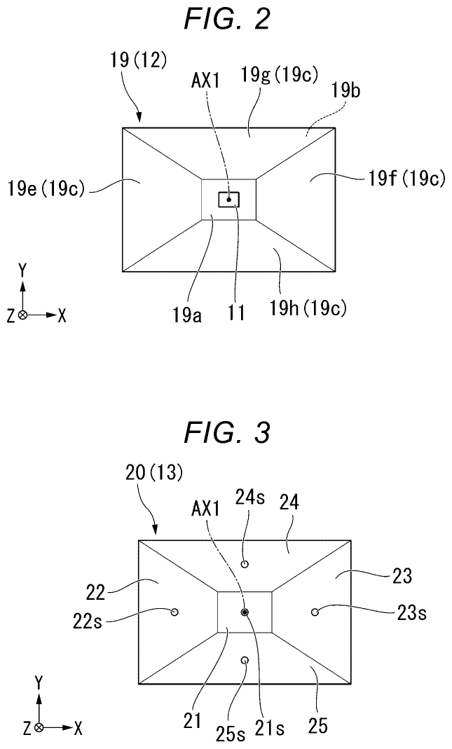

FIG. 2 is a front view of the reflection element 19 viewed in the direction along the first optical axis AX1.

The reflection element 19 has the light incident surface 19a, a light exiting surface 19b, and four reflection surfaces 19c, as shown in FIG. 2. The light incident surface 19a and the light exiting surface 19b each have a rectangular shape. The area of the light exiting surface 19b is greater than the area of the light incident surface 19a. The four reflection surfaces 19c each have a trapezoidal shape. The reflection element 19 in the present embodiment causes the light L incident via the light incident surface 19a to be totally internally reflected off the reflection surfaces 19c and exit via the light exiting surface 19b. Out of the four reflection surfaces 19c, the two reflection surfaces 19c in contact with the short sides of the rectangles that are the outer shapes of the light incident surface 19a and the light exiting surface 19b are referred to as a first reflection surface 19e and a second reflection surface 19f, and the two reflection surfaces 19c in contact with the long sides of the rectangles are referred to as a third reflection surface 19g and a fourth reflection surface 19h. The light incident surface 19a in the present embodiment corresponds to the light incident section in the claims. The light exiting surface 19b in the present embodiment corresponds to the light exiting section in the claims.

In place of the reflection element 19 in the present embodiment, a rectangular tubular reflector having a hollow interior may be used. In this case, the opening at the side where light L enters the reflection element 19 corresponds to the light incident section. The opening at the side where light L exits out of the reflection element 19 corresponds to the light exiting section. The inner circumferential surface of the reflector corresponds to the reflection surface that reflects the light L.

The second optical system 13 is provided on the optical path of the light L between the first optical system 12 and the light modulation device 28. The second optical system 13 outputs the light L output from the first optical system 12 toward the light modulation device 28. The second optical system 13 is formed of a multi-lens 20 including a plurality of lenses integrated with each other into a unit. The second optical system 13 makes the angle of divergence of the light L output from the second optical system 13 smaller than the angle of divergence of the light L entering the second optical system 13 so that the light L is closer to parallelized light and outputs the resultant light L toward the light modulation device 28.

FIG. 3 is a front view of the multi-lens 20 viewed in the direction along the first optical axis AX1.

The multi-lens 20 is formed of five lenses including a first lens 21, a second lens 22, a third lens 23, a fourth lens 24, and a fifth lens 25, as shown in FIG. 3. The first lens 21, the second lens 22, the third lens 23, the fourth lens 24, and the fifth lens 25 are each a convex lens having positive power, and part of the light L output from the first optical system 12 enters each of the five lenses. Note that the five lenses are not necessarily integrated with each other into a unit and may be formed of separate lenses. The configuration in which the five lenses are integrated with each other into a unit, however, eliminates the need for alignment of the lenses with each other, so that the projector 10 is readily assembled. Furthermore, since the lenses 21, 22, 23, 24, and 25 are each formed of a convex lens, the second optical system 13 can be readily manufactured.

The multi-lens 20 has a rectangular shape as a whole when viewed in the direction along the first optical axis AX1. The direction of the long sides of the rectangle that forms the outer shape of the multi-lens 20 coincides with the direction of the long sides of the rectangle that forms the outer shape of the light incident surface 19a and the light exiting surface 19b of the reflection element 19. The direction of the long sides of the rectangle that forms the outer shape of the multi-lens 20 coincides with the direction of the long sides of the rectangle that forms the outer shape of the effective display region of the light modulation device 28.

The first lens 21, the second lens 22, the third lens 23, the fourth lens 24, and the fifth lens 25 each have a principal point. In the present specification, assuming that each beam is caused to enter each lens from the side facing the light modulation device 28 with the height of the beam parallel to the first optical axis AX1 changed, and that the beam before incident on the lens and the beam after exiting out thereof extend to form two straight extensions, the point where the principal plane that is the trajectory of the intersection of two straight lines intersects with the first optical axis AX1 is defined as a principal point. In the following description, the principal point of the first lens 21 is referred to as a first principal point 21s. The principal point of the second lens 22 is referred to as a second principal point 22s. The principal point of the third lens 23 is referred to as a third principal point 23s. The principal point of the fourth lens 24 is referred to as a fourth principal point 24s. The principal point of the fifth lens 25 is referred to as a fifth principal point 25s.

The first lens 21 has a rectangular shape when viewed in the direction along the first optical axis AX1, and the first principal point 21s is located at the center of the rectangular shape. The second lens 22 has a trapezoidal shape, and the second principal point 22s is located in the trapezoidal shape. The third lens 23 has a trapezoidal shape, and the third principal point 23s is located in the trapezoidal shape. The fourth lens 24 has a trapezoidal shape, and the fourth principal point 24s is located in the trapezoidal shape. The fifth lens 25 has a trapezoidal shape, and the fifth principal point 25s is located in the trapezoidal shape.

When the first optical system 12 and the second optical system 13 viewed in the direction along the first optical axis AX1 are superimposed on each other, the position and shape of the first lens 21 correspond to the positions and shapes of the light incident surface 19a and the light exiting surface 19b. The position and shape of the second lens 22 correspond to the position and shape of the first reflection surface 19e. The position and shape of the third lens 23 correspond to the position and shape of the second reflection surface 19f. The position and shape of the fourth lens 24 correspond to the position and shape of the third reflection surface 19g. The position and shape of the fifth lens 25 correspond to the position and shape of the fourth reflection surface 19h.

The first principal point 21s is located on the first optical axis AX1. In contrast, the second principal point 22s is located at a position where the second principal point 22s does not coincide with the first principal point 21s. The third principal point 23s is located at a position where the third principal point 23sdoes not coincide with the first principal point 21s or the second principal point 22s. The fourth principal point 24s is located at a position where the fourth principal point 24s does not coincide with the first principal point 21s, the second principal point 22s, or the third principal point 23s. The fifth principal point 25s is located at a position where the fifth principal point 25s does not coincide with the first principal point 21s, the second principal point 22s, the third principal point 23s, or the fourth principal point 24s. That is, the second principal point 22s, the third principal point 23s, the fourth principal point 24s, and the fifth principal point 25s are each located off the first optical axis AX1.

When viewed in the direction along the first optical axis AX1, the second principal point 22s and the third principal point 23s are at positions rotationally symmetrical around the first optical axis AX1. The second principal point 22s, the first principal point 21s, and the third principal point 23s are arranged along the long side direction of the rectangle that forms the outer shape of the effective display region of the light modulation device 28. The fourth principal point 24s and the fifth principal point 25s are at positions rotationally symmetrical around the first optical axis AX1. The fourth principal point 24s, the first principal point 21s, and the fifth principal point 25s are arranged along the short side direction of the rectangle that forms the outer shape of the effective display region of the light modulation device 28.

The light modulator 14 includes a light-incident-side polarizer 27, the light modulation device 28, and a light-exiting-side polarizer 29, as shown in FIG. 1.

The light-incident-side polarizing plate 27 is provided between the second optical system 13 and the light modulation device 28, that is, on the light incidence side of the light modulation device 28.

The light modulation device 28 is formed of a single transmissive liquid crystal panel capable of color display. That is, the light modulation device 28 includes a color filter and modulates the light L based on image information to generate color image light L1, which is the source of a color image. Examples of a method for driving the liquid crystal panels include, but not limited to, a twisted nematic (TN) method, a vertical alignment (VA) method, and an in-plane switching (IPS) method.

The light-exiting-side polarizer 29 is provided between the light modulation device 28 and the condenser system 15, that is, on the light exiting side of the light modulation device 28. The orientation of the polarization axis of the light-exiting-side polarizer 29 is, for example, perpendicular to the polarization axis of the light-incident-side polarizer 27 in an imaginary plane perpendicular to the first optical axis AX1.

The condenser system 15 is provided between the light modulator 14 and the mirror 16, that is, at the light exiting side of the light modulator 14. The condenser system 15 focuses the color image light L1 output from the light modulator 14. In the present embodiment, the condenser system 15 is formed of a Fresnel lens 30. The Fresnel lens 30 functions as a convex lens having positive power. Since the condenser system 15 is formed of the Fresnel lens 30, the thickness of the condenser system 15 can be reduced, so that the dimension of the projector 10 in the rightward-leftward direction can be reduced.

The mirror 16 is provided at a position where the first optical axis AX1 and the second optical axis AX2 intersect with each other. The mirror 16 inclines by 45 degrees with respect to each of the first optical axis AX1 and the second optical axis AX2. The mirror 16 deflects the optical path of the color image light L1 output from the light modulator 14 by 90 degrees and causes the deflected color image light L1 to enter the projection optical apparatus 17. Note that when a layout in which the projection optical apparatus 17 is disposed along the first optical axis AX1 is employed, the mirror 16 is not necessary.

The projection optical apparatus 17 is formed of projection lenses. The number of projection lenses that constitute the projection optical apparatus 17 is not limited to a specific value. The projection optical apparatus 17 projects the color image light L1 output from the light modulator 14 onto the projection receiving surface such as a screen. A color image is thus displayed on the projection receiving surface.

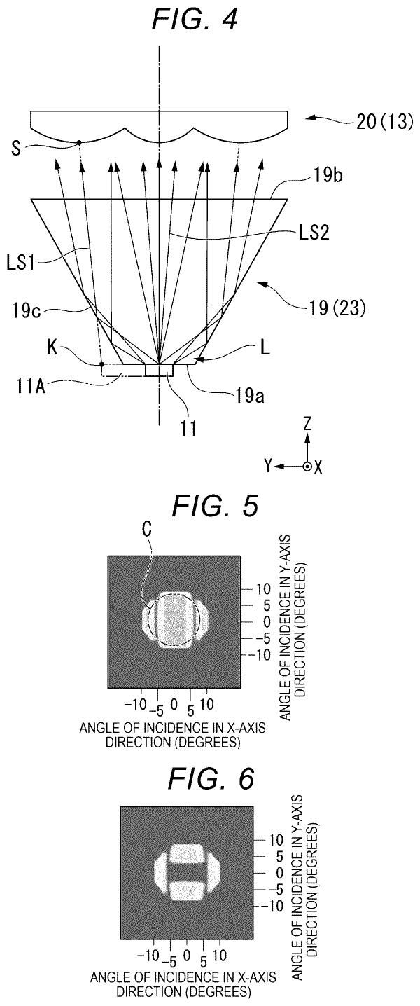

FIG. 4 is a diagrammatic view showing how the light L output from the light source 11 is reflected off the reflection element 19.

In a projector including only a single light modulation device, too large a dimension of the reflection element 19 in the optical axis direction may greatly increase the size of the projector against the purpose of size reduction, as shown in FIG. 4. To avoid the problem described above, part of the light L output from the light source 11, a beam LS1, is reflected off one of the reflection surfaces 19c of the reflection element 19 and then exits out of the reflection element 19. In contrast, another part of the light L, a beam LS2, directly exits out of the reflection element 19 without being reflected off any of the reflection surfaces 19c.

The light that is the mixture of the beam LS1, which is reflected off the reflection element 19, and the beam LS2, which is not reflected off the reflection element 19, exits out of the reflection element 19, and then enters the multi-lens 20 of the second optical system 13. In detail, at the center of the multi-lens 20, much of the light incident on the multi-lens 20 is the beam LS2, which is not reflected off the reflection element 19. In contrast, at an outer circumferential portion of the multi-lens 20, much of the light incident on the multi-lens 20 is the beam LS1, which is reflected off the reflection element 19.

The present inventor conducted a simulation on the distribution of the angle of incidence of the light incident on a light modulation device in a projector of related art. The projector of related art includes a second optical system formed of a single convex lens in place of the second optical system in the present embodiment, which is formed of the multi-lens.

FIGS. 5 and 6 show results of the simulation, and show the distribution of the angle of incidence of the light incident on a central portion of the light modulation device. FIG. 5 shows a result of the simulation in a case where both the light reflected off the reflection element and the light not reflected off the reflection element are incident on the light modulation device. FIG. 6 shows a result of the simulation in a case where only the light reflected off the reflection element is incident on the light modulation device.

In FIGS. 5 and 6, the horizontal axis represents the angle of incidence (degrees) along the X-axis direction, and the vertical axis represents the angle of incidence (degrees) along the Y-axis direction. The dark-colored region at the center represents a region where the light intensity is relatively high. The circle labeled with reference character C in FIG. 5 is a region showing ±8 degrees from the center.

The maximum angle of incidence of the light that can enter an optical system downstream from the light modulation device and is incident on the light modulation device is set to 8 degrees. That is, the light incident on the light modulation device at an angle of incidence greater than 8 degrees cannot enter the optical system downstream from the light modulation device and therefore cannot contribute to image display. According to the simulation, many of the regions where the light intensity is relatively high fall within the circle C, as shown in FIG. 5. It has therefore been demonstrated that much of the high-intensity light at the central portion of the light modulation device can enter the optical system downstream from the light modulation device. Focusing on the light reflected off the reflection element, it has been found that the regions where the light intensity is relatively high are distributed separately in upward, downward, rightward, and leftward directions in FIG. 6, that is, at four outer locations where the angle of incidence is large in correspondence with the four reflection surfaces of the reflection element, as shown in FIG. 6.

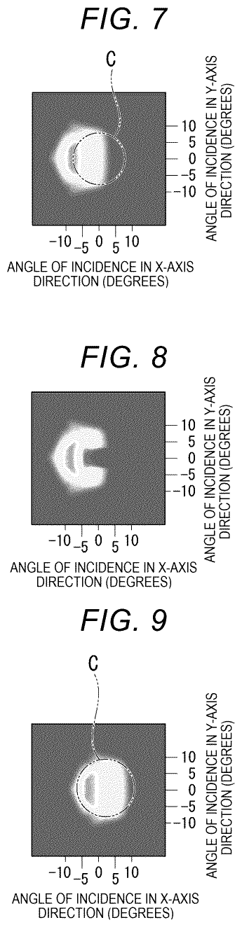

FIGS. 7 and 8 then show the distribution of the angle of incidence of the light at an outer circumferential portion (portion facing one end in long side direction) of the light modulation device. FIG. 7 shows a result of the simulation in the case where both the light reflected off the reflection element and the light not reflected off the reflection element are incident on the light modulation device. FIG. 8 shows a result of the simulation in the case where only the light reflected off the reflection element is incident on the light modulation device. The vertical and horizontal axes in FIGS. 7 and 8 are the same as those in FIGS. 5 and 6.

According to the simulation, the regions where the light intensity is relatively high are biased toward one side of the circle C and spread beyond the circle, as shown in FIG. 7. It has therefore been found that part of the high-intensity light incident on the outer circumferential portion of the light modulation device cannot enter the optical system downstream from the light modulation device. As a result, it is speculated in the projector of related art that reduction in brightness and contrast tends to occur at the outer circumferential portion of a displayed image. FIG. 8 also shows the same tendency as FIG. 7, and it has therefore been found that the reason why the regions where the light intensity is high are biased to one side is primarily due to the light reflected off the reflection element.

In contrast, the present inventor similarly conducted a simulation on the distribution of the angle of incidence of the light incident on the light modulation device in the configuration of the present embodiment.

FIG. 9 shows a result of the simulation, and shows the distribution of the angle of incidence of the light incident on the outer circumferential portion of the light modulation device. FIG. 9 shows a result of the simulation in the case where both the light reflected off the reflection element and the light not reflected off the reflection element are incident on the light modulation device. In FIG. 9, the horizontal axis represents the angle of incidence (degrees) along the X-axis direction, and the vertical axis represents the angle of incidence (degrees) along the Y-axis direction, as in FIGS. 5 to 8. The dark-colored region represents the region where the light intensity is relatively high. The circle labeled with reference character C is the region showing ±8 degrees from the center.

According to the simulation, the regions where the light intensity is relatively high are located within the circle C in the present embodiment, as shown in FIG. 9, unlike the result shown in FIG. 7. It has therefore been demonstrated in the present embodiment that much of the high-intensity light at the outer circumferential portion of the light modulation device can also enter the optical system downstream from the light modulation device. The second optical system in the present embodiment is formed of the multi-lens, which includes a plurality of lenses each having a principal point in the outer circumferential portion off the first optical axis. It is therefore speculated that the effect of these lenses allows reduction in the angle of incidence of the light at the outer circumferential portion of the light modulation device as compared with the projector of related art using only a single convex lens.

An example of a method for determining the positions of the principal points located off the first optical axis AX1, that is, the positions of the second to fifth principal points will be described below.

For example, out of the light incident on a specific lens of the second optical system 13, for example, the left lens in FIG. 4, a beam simulation is used to determine the beam LS1 corresponding to the center of gravity of the luminance out of a large number of beams reflected off the reflection element 19 at a variety of angles, as shown in FIG. 4. When the determined beam LS1 is extended toward the light incidence side, and if there is no reflection element 19, the beam LS1 can be considered to have been output from the position labeled with reference character K. Therefore, when the light source 11 and the reflection element 19 are taken as a single pseudo light source, the pseudo light source is the portion indicated by the chain line labeled with reference character 11A. The position where the beam LS1 is incident on the specific lens may be a principal point S. That is, since much of the light reflected off the reflection element 19 enters the lenses located at the outer circumferential portion of the multi-lens 20, the center of gravity of the luminance may be determined by focusing on the light output from the pseudo light source 11A, and the position of the principal point S may be determined based on the determined center of gravity.

More preferably, out of the light incident on the specific lens of the multi-lens 20, the beam corresponding to the center of gravity of the luminance may be determined based on both a large number of beams reflected off the reflection element 19 at a variety of angles and a large number of beams not reflected off the reflection element 19. That is, much of the light reflected off the reflection element 19 enters the lenses located at the outer circumferential portion of the multi-lens 20, and the light that is not actually reflected off the reflection element 19 also enters the lenses. Therefore, the center of gravity of the luminance may be determined by focusing on the light output from both the pseudo light source 11A and the actual light source 11, and the position of the principal point may be determined based on the determined center of gravity.

### Effects of First Embodiment

The projector 10 according to the present embodiment includes the light source 11, which outputs the light L, the light modulation device 28, which includes a color filter, modulates the light L output from the light source 11 to generate the color image light L1, the first optical system 12, which is provided on the optical path of the light L between the light source 11 and the light modulation device 28 and which the light L output from the light source 11 enters, the second optical system 13, which is provided on the optical path of the light L between the first optical system 12 and the light modulation device 28 and output the light L output from the first optical system 12 toward the light modulation device 28, and the projection optical apparatus 17, which projects the color image light L1 output from the light modulation device 28. The first optical system 12 includes the reflection element 19, which has the light incident surface 19a, the light exiting surface 19b having an area greater than the area of the light incident surface 19a, and the reflection surfaces 19c, and causes the light L incident via the light incident surface 19a to be reflected off the reflection surfaces 19c to output the reflected light L via the light exiting surface 19b. The second optical system 13 includes the first lens 21, which has positive power, which part of the light L output from the first optical system 12 enters, and which has the first principal point 21s on the first optical axis AX1, the second lens 22, which has positive power, which part of the light L output from the first optical system 12 enters, and which has the second principal point 22s at a position where the second principal point 22s does not coincide with the first principal point 21s when viewed in the direction along the first optical axis AX1, the third lens 23, which has positive power, which part of the light L output from the first optical system 12 enters, and which has the third principal point 23s at a position where the third principal point 23s does not coincide with the first principal point 21s or the second principal point 22s when viewed in the direction along the first optical axis AX1, the fourth lens 24, which has positive power, which part of the light L output from the first optical system 12 enters, and which has the fourth principal point 24s at a position where the fourth principal point 24s does not coincide with the first principal point 21s, the second principal point 22s, or the third principal point 23s when viewed in the direction along the first optical axis AX1, and the fifth lens 25, which has positive power, which part of the light L output from the first optical system 12 enters, and which has the fifth principal point 25s at a position where the fifth principal point 25s does not coincide with the first principal point 21s, the second principal point 22s, the third principal point 23s, or the fourth principal point 24s when viewed in the direction along the first optical axis AX1.

According to the configuration described above, in which the second optical system 13 includes the second lens 22, the third lens 23, the fourth lens 24, and the fifth lens 25, each of which has a principal point at the outer circumferential portion off the first optical axis AX1, variation in the angle of incidence of the light at the outer circumferential portion of the light modulation device 28 can be suppressed to a small value as compared with the projector of related art using only a single convex lens. As a result, a decrease in image brightness and a decrease in image contrast at the outer circumferential portion of the light modulation device 28 and other problems can be solved. Furthermore, since the amount of light that enters at large angles of incidence the outer circumferential portion of the light modulation device 28 is reduced, variation in the amount of rotation of linearly polarized light and deterioration of the characteristics of the polarizers both caused by the light described above are suppressed, so that the contrast can be improved.

In the present embodiment, in which the first principal point 21s is located on the first optical axis

AX1, variation in the angle of incidence of the light can be suppressed to a small value even at the central portion of the light modulation device. The decrease in image brightness, the decrease in image contrast, and other problems over the entire light modulation device 28 can therefore be suppressed.

### Second Embodiment

A second embodiment of the present disclosure will be described below with reference to the drawings.

The basic configuration of the projector according to the second embodiment is substantially the same as that in the first embodiment.

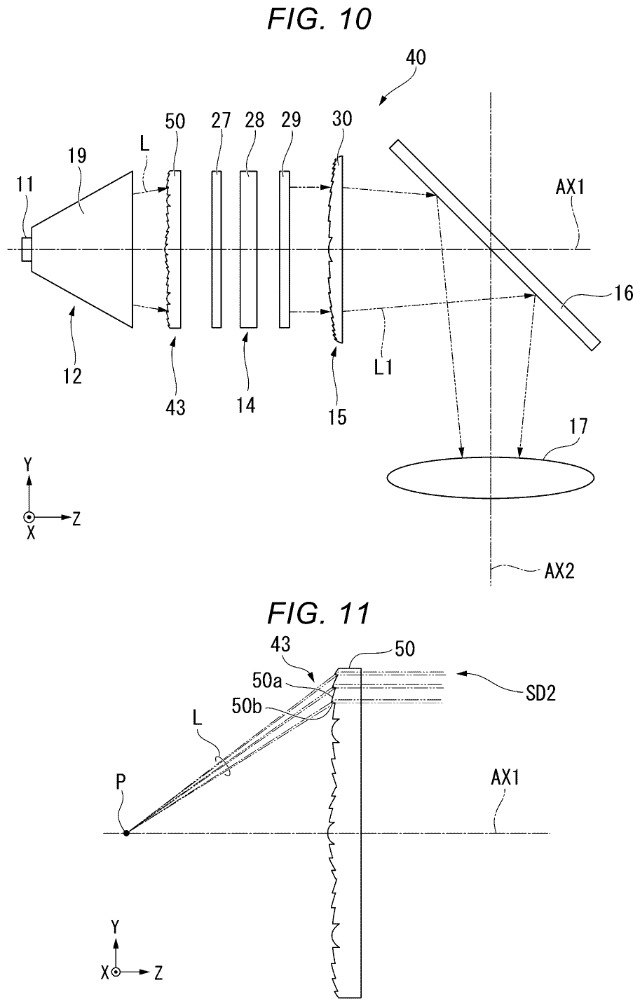

FIG. 10 is a schematic configuration diagram of a projector 40 according to the second embodiment.

In FIG. 10, components common to those in the figures used in the first embodiment have the same reference characters and will not be described.

The projector 40 according to the present embodiment includes the light source 11, the first optical system 12, a second optical system 43, the light modulator 14, the condenser system 15, the mirror 16, and the projection optical apparatus 17, as shown in FIG. 10.

A multi-lens 50, which constitutes the second optical system 43, includes a first lens, a second lens, a third lens, a fourth lens, and a fifth lens, as in the first embodiment. The first, second, third, fourth, and fifth lenses are each a lens having positive power, and part of the light L output from the first optical system 12 enters each of the first to fifth lenses.

In the first embodiment, the first, second, third, fourth, and fifth lenses are each formed of a convex lens. In contrast, the first, second, third, fourth, and fifth lenses are each formed of a Fresnel lens in the present embodiment.

The other configurations of the projector 40 are the same as those in the first embodiment.

### Effects of Second Embodiment

The present embodiment, in which variation in the angle of incidence of the light L at the outer circumferential portion of the light modulation device 28 can be suppressed to a small value by the plurality of lenses of the second optical system 43, can also provide the same effects provided by the first embodiment, for example, the decrease in image brightness and the decrease in image contrast at the outer circumferential portion of the light modulation device 28 can be suppressed.

In the present embodiment, in particular, the lenses that constitute the multi-lens 50 of the second optical system 43 are each formed of a Fresnel lens. According to the configuration described above, the thickness of the second optical system 43 can be reduced, and the following effects can further be provided.

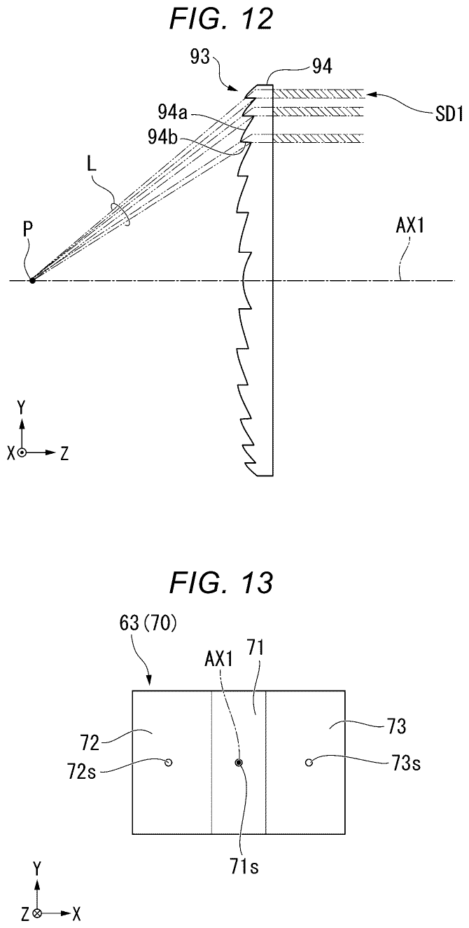

FIG. 12 is a diagrammatic view showing how the light L passes through a second optical system 93 in a projector according to Comparative Example. The projector according to Comparative Example includes the second optical system 93 formed of a single Fresnel lens 94. It is assumed in Comparative Example that the light L is output from a point light source P.

In the case of a typical convex lens, each lens surface is formed of a single continuous curved surface, whereas the Fresnel lens 94 has a lens surface so shaped that a single curved surface of a convex lens is divided in the radial direction, as shown in FIG. 12. That is, the Fresnel lens 94 has a plurality of divided lens surfaces 94a and a plurality of connecting surfaces 94b each located between two adjacent divided lens surfaces 94a. Out of the light L incident on the Fresnel lens 94, the light incident on the divided lens surfaces 94a can enter the downstream optical system, but the light incident on the connecting surfaces 94b tends to become stray light and may undesirably not be allowed to adequately enter the downstream optical system. The regions labeled with reference character SD1 are therefore each a shadowed section from which no light is output when viewed from the downstream optical system. The closer to the outer circumference of the Fresnel lens 94, the greater the inclination of the divided lens surfaces 94a and the higher the connecting surfaces 94b, so that the shadowed sections SD1 become wider. The Fresnel lens 94 therefore has an advantage of reducing the thickness of the optical system, but has a problem of light loss due to the connecting surfaces 94b.

FIG. 11 is a diagrammatic view showing how the light L passes through the second optical system 43 in a projector 40 according to the present embodiment.

In the present embodiment, a Fresnel lens different from the Fresnel lens located on the first optical axis AX1 is present at an outer circumferential portion of the multi-lens 50, which constitutes the second optical system 43, as shown in FIG. 11. Therefore, in the configuration of the present embodiment, the effective diameter of each of the Fresnel lenses is smaller than that of the Fresnel lens 94 in Comparative Example shown in FIG. 12. When compared at the same radial position in the second optical system, the width of each divided lens surface 50ain the present embodiment is smaller than the width of each of the divided lens surfaces 94a in Comparative Example. The maximum inclination of the divided lens surfaces 50a in the present embodiment is therefore smaller than the maximum inclination of the divided lens surfaces 94a in Comparative Example, so that the height of each connecting surface 50bin the present embodiment is smaller than the height of each of the connecting surfaces 94b in Comparative Example. As a result, the width of each of the shadowed sections SD2 in the present embodiment is smaller than the width of each of the shadowed sections SD1 in Comparative Example. In the present embodiment, the central portion of the Fresnel lens, that is, the lens surface without the connecting surfaces 50b is present also at the outer circumferential portion of the multi-lens 50, so that the proportion of the shadowed sections SD2 also decreases. The present embodiment therefore allows reduction in the loss of the light L caused by the second optical system 43 as compared with Comparative Example.

The technical scope of the present disclosure is not limited to the embodiments described above, and a variety of changes can be made thereto to the extent that the changes do not depart from the intent of the present disclosure. An aspect of the present disclosure can be an appropriate combination of the characteristic portions in the embodiments and the variations thereof described above.

In the embodiments described above, the second optical system includes a multi-lens formed of five lenses, and a second optical system 63 may include, for example, a multi-lens 70 formed of three lenses, as shown in FIG. 13. The multi-lens 70 in FIG. 13 includes a first lens 71, a second lens 72, and a third lens 73. A first principal point 71s of the first lens 71 is located on the first optical axis AX1. A second principal point 72s of the second lens 72 and a third principal point 73s of the third lens 73 are at positions rotationally symmetrical around the first optical axis AX1. The second principal point 72s, the first principal point 71s, and the third principal point 73s are arranged along the long side direction of the effective display region of the light modulation device.

Even the configuration shown in FIG. 13 can suppress the decreases in image brightness, the decreases in image contrast, and other factors at the outer circumferential portion of the light modulation device, especially at the ends of the image in the rightward-leftward direction corresponding to the long side direction of the light modulation device.

Furthermore, in place of the configuration in FIG. 13, the second optical system may include two lenses. The principal points of the two lenses do not need to be located on the first optical axis, but are desirably arranged along the long side direction of the effective display region of the light modulation device.

In the embodiments described above, the reflection element that constitutes the first optical system has a rectangular cross-sectional shape perpendicular to the optical axis, and may instead have a square shape, an elliptical shape, and any other shape instead of the rectangular shape.

In addition, the specific descriptions of the shapes, the numbers, the arrangements, the materials, and other factors of the components of the projector are not limited to those in the embodiments described above and can be changed as appropriate.

### Summary of Present Disclosure

The present disclosure will be summarized below as additional remarks.

Additional remark 1

A projector including a light source that outputs light, a light modulation device that includes a color filter and modulates the light output from the light source based on image information to generate color image light, a first optical system which is provided on the optical path of the light between the light source and the light modulation device and which the light output from the light source enters, a second optical system which is provided on the optical path of the light between the first optical system and the light modulation device and which outputs the light output from the first optical system toward the light modulation device, and a projection optical apparatus that projects the color image light output from the light modulation device, the first optical system including a reflection element that includes a light incident section, a light exiting section having an area greater than the area of the light incident section, and a reflection surface, and reflects the light incident via the light incident section off the reflection surface to output the reflected light via the light exiting section, the second optical system including a first lens which has positive power, which part of the light output from the first optical system enters, and which has a first principal point, and a second lens which has positive power, which part of the light output from the first optical system enters, and which has a second principal point at a position where the second principal point does not coincide with the first principal point when viewed in the direction along the optical axis of the light modulation device.

The configuration of the additional remark 1, in which the first and second lenses provided in the second optical system provide the effect of reducing variation in the angle of incidence of the light at an outer circumferential portion of the light modulation device to a small value, can suppress the decrease in image brightness, the decrease in image contrast, and other factors at the outer circumferential portion of the light modulation device.

Additional remark 2

The projector described in the additional remark 1, in which the first principal point is located on the optical axis.

The configuration of the additional remark 2, which can reduce the variation in the angle of incidence of the light also at a central portion of the light modulation device to a small value, can suppress the decrease in image brightness, the decrease in image contrast, and other factors over the entire light modulation device.

Additional remark 3

The projector described in the additional remark 2, in which the second optical system further includes a third lens which has positive power, which part of the light output from the first optical system enters, and which has a third principal point at a position where the third principal point does not coincide with the first principal point or the second principal point when viewed in the direction along the optical axis, the second and third principal points are at positions rotationally symmetrical around the optical axis when viewed in the direction along the optical axis.

The configuration of the additional remark 3 allows the decrease in image brightness, the decrease in image contrast, and other display characteristics to be rotationally symmetrical around the optical axis along one direction.

Additional remark 4

The projector described in the additional remark 3, in which an effective display region of the light modulation device has a rectangular shape when viewed in the direction along the optical axis, and the second, first, and third principal points are arranged along the long side direction of the rectangular shape.

The configuration of the additional remark 4 allows the decrease in image brightness, the decrease in image contrast, and other display characteristics to be symmetrical with respect to the long side direction of the effective display region of the light modulation device.

Additional remark 5

The projector described in the additional remark 4, in which the second optical system further includes a fourth lens which has positive power, which part of the light output from the first optical system enters, and which has a fourth principal point at a position where the fourth principal point does not coincide with the first principal point, the second principal point, or the third principal point when viewed in the direction along the optical axis, and a fifth lens which has positive power, which part of the light output from the first optical system enters, and which has a fifth principal point at a position where the fifth principal point does not coincide with the first principal point, the second principal point, the third principal point, or the fourth principal point when viewed in the direction along the optical axis, the fourth and fifth principal points are at positions rotationally symmetrical around the optical axis when viewed in the direction along the optical axis, and the fourth, first, and fifth principal points are arranged along the short side direction of the rectangular shape.

The configuration of the additional remark 5 allows the decrease in image brightness, the decrease in image contrast, and other display characteristics to be rotationally symmetrical around both the long side direction and the short side direction of the effective display region of the light modulation device.

Additional remark 6

The projector described in the additional remark 5, in which the light incident section and the light exiting section of the reflection element each have a rectangular shape when viewed in the direction along the optical axis, the reflection surface includes first, second, third, and fourth reflection surfaces corresponding to four sides of the rectangular shape, the position of the first lens corresponds to the positions of the light incident section and the light exiting section, the position of the second lens corresponds to the position of the first reflection surface, the position of the third lens corresponds to the position of the second reflection surface, the position of the fourth lens corresponds to the position of the third reflection surface, and the position of the fifth lens corresponds to the position of the fourth reflection surface.

The configuration of the additional remark 6allows the characteristics of the second optical system to be optimized in accordance with the shape of the reflection element.

Additional remark 7

The projector described in any one of the additional remarks 1 to 6, in which the lenses that constitute the second optical system are each a convex lens.

The configuration of the additional remark 7 allows the second optical system to be readily manufactured.

Additional remark 8

The projector described in any one of the additional remarks 1 to 6, in which the lenses that constitute the second optical system are each a Fresnel lens.

The configuration of the additional remark 8 allows reduction in the size of the second optical system in the optical axis direction. Furthermore, light loss can be reduced as compared with a case where the second optical system is formed of a single Fresnel lens.

Additional remark 9

The projector described in any one of the additional remarks 1 to 8, in which the lenses that constitute the second optical system are formed of an integral member.

The configuration of the additional remark 9 eliminates the need for alignment of the lenses with each other, so that the projector is readily assembled.

What is claimed is:

1. A projector comprising:
a light source that outputs light;
a light modulation device that includes a color filter and modulates the light output from the light source based on image information to generate color image light;
a first optical system which is provided on an optical path of the light between the light source and the light modulation device and which the light output from the light source enters;
a second optical system which is provided on the optical path of the light between the first optical system and the light modulation device and which outputs the light output from the first optical system toward the light modulation device; and
a projection optical apparatus that projects the color image light output from the light modulation device, wherein
the first optical system includes
a reflection element that includes a light incident section, a light exiting section having an area greater than an area of the light incident section, and a reflection surface, and reflects the light incident via the light incident section off the reflection surface to output the reflected light via the light exiting section, and
the second optical system includes
a first lens which has positive power, which part of the light output from the first optical system enters, and which has a first principal point, and
a second lens which has positive power, which part of the light output from the first optical system enters, and which has a second principal point at a position where the second principal point does not coincide with the first principal point when viewed in a direction along an optical axis of the light modulation device.

2. The projector according to claim 1, wherein the first principal point is located on the optical axis.

3. The projector according to claim 2, wherein
the second optical system further includes a third lens which has positive power, which part of the light output from the first optical system enters, and which has a third principal point at a position where the third principal point does not coincide with the first principal point or the second principal point when viewed in the direction along the optical axis, and
the second and third principal points are at positions rotationally symmetrical around the optical axis when viewed in the direction along the optical axis.

4. The projector according to claim 3, wherein
an effective display region of the light modulation device has a rectangular shape when viewed in the direction along the optical axis, and
the second, first, and third principal points are arranged along a long side direction of the rectangular shape.

5. The projector according to claim 4, wherein
the second optical system further includes
a fourth lens which has positive power, which part of the light output from the first optical system enters, and which has a fourth principal point at a position where the fourth principal point does not coincide with the first principal point, the second principal point, or the third principal point when viewed in the direction along the optical axis, and
a fifth lens which has positive power, which part of the light output from the first optical system enters, and which has a fifth principal point at a position where the fifth principal point does not coincide with the first principal point, the second principal point, the third principal point, or the fourth principal point when viewed in the direction along the optical axis,
the fourth and fifth principal points are at positions rotationally symmetrical around the optical axis when viewed in the direction along the optical axis, and
the fourth, first, and fifth principal points are arranged along a short side direction of the rectangular shape.

6. The projector according to claim 5, wherein
the light incident section and the light exiting section of the reflection element each have a rectangular shape when viewed in the direction along the optical axis,
the reflection surface includes first, second, third, and fourth reflection surfaces corresponding to four sides of the rectangular shape,
a position of the first lens corresponds to positions of the light incident section and the light exiting section,
a position of the second lens corresponds to a position of the first reflection surface,
a position of the third lens corresponds to a position of the second reflection surface,
a position of the fourth lens corresponds to a position of the third reflection surface, and
a position of the fifth lens corresponds to a position of the fourth reflection surface.

7. The projector according to claim 1, wherein
the lenses that constitute the second optical system are each a convex lens.

8. The projector according to claim 1, wherein
the lenses that constitute the second optical system are each a Fresnel lens.

9. The projector according to claim 1, wherein
the lenses that constitute the second optical system are formed of an integral member.
